(19) United States
(12) Patent Application Publication
(10) Pub. No.: US 2020/0412271 A1
(43) Pub. Date: Dec. 31, 2020

(54) Adaptive Control Method for Three-Phase Power Rectifier and Device Thereof

(71) Applicant: Harbin Institute of Technology, Harbin (CN)

(72) Inventors: Ligang Wu, Harbin (CN); Jianxing Liu, Harbin (CN); Guanghui Sun, Harbin (CN); Yunfel Yin, Harbin (CN); Hao Lin, Harbin (CN)

(21) Appl. No.: 16/861,937

(22) Filed: Apr. 29, 2020

(30) Foreign Application Priority Data
Jun. 26, 2019 (CN) 201910562338.9

(51) Int. Cl. H02M 7/219; H02M 1/12

(52) U.S. Cl. CPC H02M 7/219; H02M 2001/0003; H02M 1/126

(57) ABSTRACT

The present invention provides an adaptive control method for a three-phase power rectifier and a device thereof that has anti-interference capability, can produce a desired DC voltage or low-harmonic-distortion current, allows for a simple structure and is easy to implement, in the technical field of power electronics control. The present invention considers an unknown load as an unknown disturbance, and use an adaptive controller to process the unknown disturbance of the three-phase power rectifier so that a DC-side voltage of the three-phase power rectifier tracks a reference value, to obtain a reference grid current; and uses an H_{∞} controller to track the reference grid current, to obtain a control input for the three-phase power rectifier. Simulation results demonstrate effectiveness of the present invention.

### CROSS-REFERENCE TO RELATED APPLICATIONS

This application claims the benefit under 35 U.S.C. § 119 of Chinese Patent Application No. 201910562338.9, filed Jun. 26, 2019, which application is incorporated herein by reference in its entirety.

### FIELD

The present disclosure relates to a control method for a three-phase power rectifier and a control device thereof, in particular to an adaptive control method for a three-phase power rectifier with anti-interference capability and a device thereof, in the technical field of power electronics control.

### BACKGROUND

Renewable power generation has alleviated a lot of emergencies facing the world today, e.g., environmental pollution and resource depletion. Three-phase power converters play an important role in the processing of renewable energies, and have received widespread attention in recent years. Generally speaking, grid-connected converters regulate a DC-side voltage to a reference value and minimize the harmonic distortion of a grid current. Therefore, it is desirable to obtain a good control strategy to achieve the results above.

As is known to all, it is difficult to obtain an effective control strategy that produces a desired DC voltage or low-harmonic-distortion current, while allowing the controller to have a simple structure and be easy to implement. In recent years, by combining methods such as PI Control, Sliding Mode Control, Model Predictive Control, and Fuzzy Control, great progress has been made in the control of three-phase power converters. Linear PI controllers are simple with easy-to-tune parameters, and thus are widely used in industrial applications; however, they do not work well with parameters with uncertainty. Sliding Mode Control is robust, but has a chattering problem that is difficult to solve and causes power consumption and shortens the lifespan of switching elements when used in three-phase converters; in addition, parameter tuning of Sliding Mode Control is complicated in industrial implementations. As compared with the two methods above, Finite Control Set Model Predictive Control does not require a Pulse Width Modulation module, and is easy to configure and implement in industrial applications; however, its drawback includes the changing switching frequency, which may increase the design complexity of the output filter, and thus the computational burden and cost of the controller in order to solve the optimization problem.

The subject of adaptive control studies is a system with a certain degree of uncertainty, i.e., the object or environment to be controlled has a mathematical model that is not completely determined. H_{∞} is a measure of the gain of a transfer function, i.e., the magnification ratio of the system output to the system input. For linear systems, Linear Matrix Inequality (LMI) for closed-loop stability analysis can be used directly in problem formulation, to find an LMI with certain controller parameters, which can be done by MATLAB.

### SUMMARY

In view of the drawbacks above, the present disclosure provides an adaptive control method for a three-phase power rectifier that has anti-interference capability, can produce a desired DC voltage or low-harmonic-distortion current, allows for a simple structure, and is easy to implement, as well as a device thereof.

The present disclosure provides an adaptive control method for a three-phase power rectifier, the method including: considering an unknown load as an unknown disturbance, and using an adaptive controller to process the unknown disturbance of the three-phase power rectifier so that a DC-side voltage of the three-phase power rectifier tracks a reference value, to obtain a reference grid current; and, using an H_{∞} controller to track the reference grid current, to obtain a control input for the three-phase power rectifier, where H_{∞} denotes a magnification ratio of an output to an input of the three-phase power rectifier.

Preferably, the adaptive controller can be expressed as Equation (1) below:

p*=ke₁(t)+Cx₁(t)\hat{p}(t) (1)

where p* is a reference active power; k is a proportional gain of an error; e₁(t) is the tuning error, e₁(t)=x₁*−x₁(t); \hat{p} is an interference-related estimate, \dot{\hat{p}}(t)=ηx₁(t)e₁(t), with η being an adaptive tuning parameter; x₁* is a tracking reference signal; x₁(t)=½v_{dc}²(t); v_{dc}(t) is the DC-side voltage of the three-phase power rectifier; C denotes a DC-side capacitance of the three-phase power rectifier.

Preferably, the H_{∞} controller can be expressed as Equation (2) below:

$$[ \begin{matrix}{u}_{d} ( t ) \\ {u}_{q} ( t )\end{matrix} ] = [ \begin{matrix}- \frac{L}{{v}_{dc} ( t )} {k}_{d} {ɛ}_{d} ( t ) \\ - \frac{L}{{v}_{dc} ( t )} {k}_{q} {ɛ}_{q} ( t )\end{matrix} ] + [ \begin{matrix}\frac{{e}_{d}}{{v}_{dc} ( t )} + \frac{L}{{v}_{dc} ( t )} ω {i}_{q} ( t ) \\ \frac{{e}_{q}}{{v}_{dc} ( t )} - \frac{L}{{v}_{dc} ( t )} ω {i}_{d} ( t )\end{matrix} ] \qquad ( 2 )$$

where u_{d}(t) is a d-axis control input of the three-phase power rectifier in a two-phase rotating coordinate system; u_{q}(t) is a q-axis control input of the three-phase power rectifier in the two-phase rotating coordinate system; e_{d} is a d-axis grid voltage in the two-phase rotating coordinate system; e_{q} is a q-axis grid voltage in the two-phase rotating coordinate system; L is a filter inductance of the three-phase power rectifier; ω is a grid voltage frequency; i_{d}(t) is a d-axis inductor current of the three-phase power rectifier in the two-phase rotating coordinate system; i_{q}(t) is q-axis inductor current of the three-phase power rectifier in the two-phase rotating coordinate system; v_{dc}(t) is the DC-side voltage of the three-phase power rectifier; ε_{d}(t) is a d-axis current tracking error in the two-phase rotating coordinate system; ε_{q}(t) is a q-axis current tracking error in the two-phase rotating coordinate system; k_{d} is a control parameter in a loop controlling i_{d}; k_{q} is a control parameter in a loop controlling i_{q}; L is a filter inductance of the three-phase power rectifier.

Preferably, k_{d} is obtained by the following approach: for

$$[ \begin{matrix}{\dot{ɛ}}_{d} ( t ) \\ {\dot{ɛ}}_{q} ( t )\end{matrix} ] = [ \begin{matrix}- {k}_{d} {ɛ}_{d} ( t ) + {ω}_{d} ( t ) \\ - {k}_{q} {ɛ}_{q} ( t ) + {ω}_{q} ( t )\end{matrix} ] ,$$

where ω_{d}(t) is an unknown disturbance to

$${ɛ}_{d} ( t ) , {ω}_{d} ( t ) = {i}_{d}^{*} + \frac{r}{L} {i}_{d} ( t ) ;$$

ω_{q}(t) is an unknown disturbance to

$${ɛ}_{q} ( t ) , {ω}_{q} ( t ) = {i}_{q}^{*} + \frac{r}{L} {i}_{q} ( t ) ;$$

r is a parasitic resistance of the three-phase power rectifier, given a control indicator γ_{d} of the H_{∞} controller and

$${k}_{d} = \frac{{l}_{d}}{{h}_{d}} ,$$

finding a solution that satisfies

$$[ \begin{matrix}- 2 {l}_{d} & {h}_{d} & 1 \\ {h}_{d} & - {γ}_{d} & 0 \\ 1 & 0 & - {γ}_{d}\end{matrix} ] \leq 0 ,$$

in which case

$$[ \begin{matrix}{\dot{ɛ}}_{d} ( t ) \\ {\dot{ɛ}}_{q} ( t )\end{matrix} ] = [ \begin{matrix}- {k}_{d} {ɛ}_{d} ( t ) + {ω}_{d} ( t ) \\ - {k}_{q} {ɛ}_{q} ( t ) + {ω}_{q} ( t )\end{matrix} ]$$

is stable and the corresponding k_{d} is what is desired, with l_{d} being a parameter variable of the H_{∞} controller, and h_{d} being a parameter variable of the H_{∞} controller; k_{q} is obtainable by a similar approach.

The present disclosure provides a computer-readable storage apparatus, the computer-readable storage apparatus storing a computer program which, when executed, implements a control method above.

The present disclosure provides an adaptive control device for a three-phase power rectifier, including a storage apparatus, a processor, and a computer program stored on the storage apparatus and executable by the processor, wherein the processor is configured to execute the computer program to implement a control method above.

The present disclosure also provides an adaptive control device for a three-phase power rectifier, the device including: a voltage loop control module, configured to, by considering an unknown load as an unknown disturbance and using an adaptive controller, process the unknown disturbance of the three-phase power rectifier so that a DC-side voltage of the three-phase power rectifier tracks a reference value, to obtain a reference grid current; and, a current loop control module, configured to use an H_{∞} controller to track the reference grid current, to obtain a control input for the three-phase power rectifier, where H_{∞} denotes a magnification ratio of an output to an input of the three-phase power rectifier.

Preferably, the adaptive controller is an electronic device that outputs p*:

p*=ke₁(t)+Cx₁(t)\hat{p}(t)

where p* is a reference active power; k is a proportional gain of an error; e₁(t) is the tuning error, e₁(t)=x₁*−x₁(t); \hat{p} is an interference-related estimate, \dot{\hat{p}}(t)=ηx₁(t)e₁(t), with η being an adaptive tuning parameter; x₁* is a tracking reference signal; x₁(t)=½v_{dc}²(t); v_{dc}(t) is the DC-side voltage of the three-phase power rectifier; C denotes a DC-side capacitance of the three-phase power rectifier.

Preferably, the H_{∞} controller is an electronic device that outputs

$$[ \begin{matrix}{u}_{d} ( t ) \\ {u}_{q} ( t )\end{matrix} ] \text{:}$$

$$[ \begin{matrix}{u}_{d} ( t ) \\ {u}_{q} ( t )\end{matrix} ] = [ \begin{matrix}- \frac{L}{{v}_{dc} ( t )} {k}_{d} {ɛ}_{d} ( t ) \\ - \frac{L}{{v}_{dc} ( t )} {k}_{q} {ɛ}_{q} ( t )\end{matrix} ] + [ \begin{matrix}\frac{{e}_{d}}{{v}_{dc} ( t )} + \frac{L}{{v}_{dc} ( t )} ω {i}_{q} ( t ) \\ \frac{{e}_{q}}{{v}_{dc} ( t )} - \frac{L}{{v}_{dc} ( t )} ω {i}_{d} ( t )\end{matrix} ]$$

where u_{d}(t) is a d-axis control input of the three-phase power rectifier in a two-phase rotating coordinate system; u_{q}(t) is a q-axis control input of the three-phase power rectifier in the two-phase rotating coordinate system; e_{d} is a d-axis grid voltage in the two-phase rotating coordinate system; eₐ is a q-axis grid voltage in the two-phase rotating coordinate system; L is a filter inductance of the three-phase power rectifier; co is a grid voltage frequency; i_{d}(t) is a d-axis inductor current of the three-phase power rectifier in the two-phase rotating coordinate system; i_{q}(t) is q-axis inductor current of the three-phase power rectifier in the two-phase rotating coordinate system; v_{dc}(t) is the DC-side voltage of the three-phase power rectifier; ε_{d}(t) is a d-axis current tracking error in the two-phase rotating coordinate system; E_{q}(t) is a q-axis current tracking error in the two-phase rotating coordinate system; k_{d} is a control parameter in a loop controlling i_{d}; k_{q} is a control parameter in a loop controlling i_{q}; L is a filter inductance of the three-phase power rectifier.

Preferably,

$${k}_{d} = \frac{{l}_{d}}{{h}_{d}} , [ \begin{matrix}- 2 {l}_{d} & {h}_{d} & 1 \\ {h}_{d} & - {γ}_{d} & 0 \\ 1 & 0 & - {γ}_{d}\end{matrix} ] \leq 0 ,$$

γ_{d} is a control indicator of the H_{∞} controller, l_{d} is a parameter variable of the H_{∞} controller and h_{d} is a parameter variable of the H_{∞} controller;

$${k}_{q} = \frac{{l}_{q}}{{h}_{q}} , [ \begin{matrix}- 2 {l}_{q} & {h}_{q} & 1 \\ {h}_{q} & - {γ}_{q} & 0 \\ 1 & 0 & - {γ}_{q}\end{matrix} ] \leq 0 ,$$

γ_{d} is a control indicator of the H_{∞} controller, l_{q} is a parameter variable of the H_{∞} controller and h_{q} is a parameter variable of the H_{∞} controller.

The present disclosure produces the following advantageous effects. The method according to the present disclosure can reduce the harmonic distortion of the three-phase grid-connected rectifier and improve its practicability. The control of the present disclosure includes two control loops: an outer loop for voltage regulation, and an inner loop for current tracking. The outer loop includes an adaptive controller, rejecting an unknown disturbance and making the DC-side voltage to track a reference value, where the unknown disturbance may be a load resistance. The inner loop includes an H_{∞} controller, directly controlling the current tracking result. Simulation results of the three-phase power rectifier show that under the control of the method according to the present disclosure, output voltage regulation, current tracking, robustness, and harmonic distortion improvement performances of the three-phase power rectifier are improved.

The use of an adaptive controller in the voltage outer loop, as compared with the combination of Sliding Mode Control and Extended State Observer, eliminates the need of an observer, simplifies the control structure, makes industrial realization easier, and reduces processor computational burden. On the other hand, the method achieves a better performance. Simulation results show that the controller has less overshoot and a higher convergence rate. This is because the controller can reduce the impact of the unknown disturbance on the system, and hence a better estimation performance.

Compared with other methods such as Sliding Mode Control, the H_{∞} controller has a simpler control structure; the controller parameters can be obtained using an LMI toolbox of MATLAB; parameter tuning is relatively easy; specific anti-interference abilities of the system can be determined according to respective applications, which in turn can determine a suitable performance indicator γ of the H_{∞} controller. It is not required that the indicator be the minimum one, and hence a great practicability of the control method.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a circuit diagram of a three-phase grid-connected rectifier according to the present disclosure;

FIG. 2 is a schematic diagram of an adaptive controller according to the present disclosure;

FIG. 3 is a schematic diagram of an Ho controller according to the present disclosure;

FIG. 4 is a diagram of voltage change of a DC-side output capacitor;

FIG. 5 is a diagram of current harmonic analysis under an ESO-SOSM controller;

FIG. 6 is a diagram of current harmonic analysis under the control of the present disclosure;

FIG. 7 is a diagram of robust performance analysis under an ESO-SOSM controller and the present disclosure;

FIG. 8 is a diagram of current i_{d} tracking under an ESO-SOSM controller;

FIG. 9 is a diagram of current i_{d} tracking under the control of the present disclosure;

FIG. 10 is a diagram of current i_{q} tracking under an ESO-SOSM controller; and,

FIG. 11 is a diagram of current i_{q} tracking under the control of the present disclosure.

### DETAILED DESCRIPTION

The technical solutions of embodiments of the present disclosure will be described clearly and fully in conjunction with the accompanying drawings. As a matter of course, the embodiments described are only some of the embodiments of the present invention. Those skilled in the art can, based on the embodiments described herein, obtain other embodiments without inventive efforts; those other embodiments shall fall within the scope of the present invention.

It should be noted that, in the case of no conflict, the embodiments and features in the embodiments of the present disclosure may be combined with each other.

The present invention is further described below in conjunction with the accompanying drawings and specific embodiments, which shall not be construed as limiting the scope of the present invention.

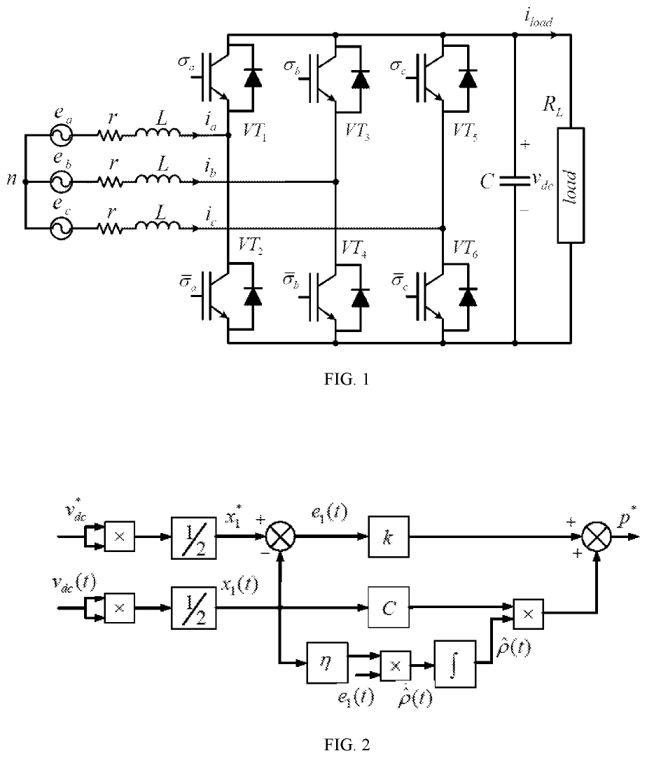

As shown in FIG. 1, in an embodiment a three-phase power rectifier is connected to a power grid through a filter inductor L, the three-phase bridge rectifier realizing AC/DC (Alternating Current to Direct Current) conversion, and an external load and a DC-side capacitor C are connected in parallel. The three-phase power rectifier has parameters as shown in Table 1.

TABLE 1
Parameters of the three-phase power rectifier

| Variable | Description |
|---|---|
| e_{abc} = {eₐ, e_{b}, e_{c}}^{T} | Grid voltage in abc coordinate system |
| e_{dq} = {e_{d}, e_{q}}^{T} | Grid voltage in dq coordinate system |
| i_{abc} = {iₐ, i_{b}, i_{c}}^{T} | Inductor current in abc coordinate system |
| i_{dq} = {i_{d}, i_{q}}^{T} | Inductor current in dq coordinate system |
| u_{abc} = {uₐ, u_{b}, u_{c}}^{T} | Control input in abc coordinate system |
| u_{dq} = {u_{d}, u_{q}}^{T} | Control input in dq coordinate system |
| L | Filter inductance |
| C | DC-side capacitance |
| r | Parasitic resistance |
| ω | Grid voltage frequency |
| v_{dc} | Output capacitor voltage |

By Park transform, {g}_{αβ}=A{g}_{abc}, {g}_{dg}=B{g}_{αβ}, where

$$A = \sqrt{\frac{2}{3}} \begin{matrix}{e}^{′} & & & i , \\ \hat{e} 1 & - \frac{1}{2} & - \frac{1}{2} & i , \\ \hat{e} & & & i , \\ \hat{e} & & & i , \\ \hat{e} & & & i , \\ \hat{e} 0 & \frac{\sqrt{3}}{2} & - \frac{\sqrt{3}}{2} & i , \\ e & & & i ,\end{matrix} , B = \begin{matrix}{e}^{′} & cos q & sin q & {u}^{‘} \\ \hat{e} & & & {u}^{′} \\ \hat{e} & sin q & cos q & {u}^{′} \\ e & & & \hat{u}\end{matrix} ,$$

and the three-phase power rectifier has a dynamic model that can be expressed as:

$${i}_{dq} ( t ) = - \frac{r}{L} {i}_{dq} ( t ) - J ω {i}_{dq} ( t ) + \frac{{e}_{dq}}{L} - \frac{1}{L} {u}_{dq} {v}_{dc} ( t ) \\ {\dot{v}}_{dc} ( t ) = - \frac{1}{{R}_{L} C} {v}_{dc} ( t ) + \frac{1}{C} {u}_{dq}^{T} ( t ) {i}_{dq} ( t ) \qquad ( 1 )$$

with R_{L} being the load resistance.

The on-off states of the three-phase power rectifier in the dq coordinate system are shown in Table 2.

TABLE 2
The on-off states and corresponding voltage vectors in the
abc coordinate system

| uₐ | u_{b} | u_{c} | Voltage Vector |
|---|---|---|---|
| 0 | 0 | 0 | V₀ = 0 |
| 1 | 0 | 0 | ${V}_{1} = \frac{2}{3} {v}_{dc}$ |
| 1 | 1 | 0 | ${V}_{2} = \frac{1}{3} {v}_{dc} + j \frac{\sqrt{3}}{3} {v}_{dc}$ |
| 0 | 1 | 0 | ${V}_{3} = - \frac{1}{3} {v}_{dc} + j \frac{\sqrt{3}}{3} {v}_{dc}$ |
| 0 | 1 | 1 | ${V}_{4} = - \frac{2}{3} {v}_{dc}$ |
| 0 | 0 | 1 | ${V}_{5} = - \frac{1}{3} {v}_{dc} - j \frac{\sqrt{3}}{3} {v}_{dc}$ |
| 1 | 0 | 1 | ${V}_{6} = \frac{1}{3} {v}_{dc} - j \frac{\sqrt{3}}{3} {v}_{dc}$ |
| 1 | 1 | 1 | V₇ = 0 |

The control objective of the embodiment is to select an on-off state such that the output voltage v_{dc} tracks a set value v_{dc}*.

The adaptive control method for the three-phase power rectifier according to the embodiment includes two control loops: an outer loop for voltage regulation, and an inner loop for current tracking.

The voltage regulation loop in this embodiment considers the unknown load as an unknown disturbance. An adaptive controller is used to process the unknown disturbance of the three-phase power rectifier so that the DC-side voltage v_{dc} of the three-phase power rectifier tracks a reference value v_{dc}*, to obtain a reference grid current: v_{dc}→v_{dc}*, with v_{dc}* being a constant.

The voltage regulation loop uses the adaptive controller to regulate the DC output voltage, and the following relationship stands:

$${v}_{dc} ( t ) {\dot{v}}_{dc} ( t ) = - \frac{1}{{R}_{L} C} {v}_{dc}^{2} ( t ) + \frac{1}{C} {v}_{dc} ( t ) {u}_{dq}^{T} ( t ) {i}_{dq}^{*} ( t ) \qquad ( 2 )$$

Equation (2) can be rewritten as:

$${\dot{x}}_{1} ( t ) = \frac{1}{C} {p}^{*} - ρ {x}_{1} ( t ) \\ {y}_{1} ( t ) = {x}_{1} ( t ) \qquad ( 3 )$$

where x₁(t)=½v_{dc}²(t) p*=v_{dc}u_{dq}^{T}i_{dq}*, y₁(t) is the control output, and

$$ρ = \frac{2}{{R}_{L} C} ,$$

as R_{L} is the unknown load, a slowly changing unknown interference. In a preferred embodiment, the adaptive controller can be expressed as:

p*=ke₁(t)+Cx₁(t)\hat{p}(t) (4)

where p* is a reference active power; k is the proportional gain of the voltage regulation loop; e₁(t)=x₁*−x₁(t) denotes the tuning error, with x₁* being a tracking reference signal; \hat{p} is an adaptive law and an interference-related estimate, which can be expressed as:

\dot{\hat{p}}(t)=ηx₁(t)e₁(t) (5)

where η is an adaptive tuning parameter of the voltage regulation loop; in this case the control output y₁(t) approximates to the tracking reference signal x₁*, i.e., the adaptive controller (4) regulates the output voltage so that it tracks the reference value v_{dc}*. If, instead, an Extended State Observer is used to estimate, Cx₁(t)\hat{p}(t) needs to be considered altogether as an interference; however, in the embodiment, only \hat{p}(t) needs to be an estimate. Therefore, this embodiment produces a better estimation result and control result than using an observer.

FIG. 2 is a schematic diagram of an adaptive controller according to an embodiment of the present disclosure. In the embodiment, the load resistance is considered as an unknown interference, and an adaptive controller is used to control the unknown load. This control algorithm is better than using a disturbance observer to process the unknown load, and has a simple structure, is easier to implement in industrial applications, requires less computational resources, eliminates the need of an additional processor for the unknown load, and improves system dynamic performance.

The current tracking loop of the embodiment uses an H_{∞} controller to track the reference grid current, to obtain the control input for the three-phase power rectifier. The current tracking set value is i_{d}*, i_{q}*, where i_{d}* is generated by the voltage regulation loop, and i_{q}* is a set value: i_{d}→i_{d}*, i_{q}→i_{q}*.

The voltage regulation loop outputs a reference active power p*; the user defines a reference reactive power q*. Based on transient response theory, the following relationship stands between the reference current i_{d}*, i_{q}*, and reference active power p* and reference reactive power q*:

$$[ \begin{matrix}{i}_{d}^{*} \\ {i}_{q}^{*}\end{matrix} ] = \frac{1}{{e}_{d}^{2} + {e}_{q}^{2}} [ \begin{matrix}{e}_{d} & {e}_{q} \\ {e}_{q} & - {e}_{d}\end{matrix} ] [ \begin{matrix}{p}^{*} \\ {q}^{*}\end{matrix} ] = \frac{1}{{e}_{d}} [ \begin{matrix}{p}^{*} \\ - {q}^{*}\end{matrix} ] \qquad ( 6 )$$

Generally, the system is in a unit power factor state when the reference reactive power is set to be zero, i.e., is i_{q}*=0.

The current tracking error is:

$${ɛ}_{dq} ( t ) = [ \begin{matrix}{ɛ}_{d} ( t ) \\ {ɛ}_{q} ( t )\end{matrix} ] = [ \begin{matrix}{i}_{d}^{*} - {i}_{d} ( t ) \\ {i}_{q}^{*} - {i}_{q} ( t )\end{matrix} ] \qquad ( 7 )$$

Then the derivative of the current tracking error is:

$$[ \begin{matrix}{\dot{ɛ}}_{d} ( t ) \\ {\dot{ɛ}}_{q} ( t )\end{matrix} ] = [ \begin{matrix}{i}_{d}^{*} + \frac{r}{L} {i}_{d} ( t ) - \frac{{e}_{d}}{L} - ω {i}_{q} ( t ) \\ {i}_{q}^{*} + \frac{r}{L} {i}_{q} ( t ) - \frac{{e}_{q}}{L} + ω {i}_{d} ( t )\end{matrix} ] + \frac{{v}_{dc} ( t )}{L} [ \begin{matrix}{u}_{d} ( t ) \\ {u}_{q} ( t )\end{matrix} ] \qquad ( 8 )$$

In a preferred embodiment, the H_{∞} controller can be expressed as:

$$[ \begin{matrix}{u}_{d} ( t ) \\ {u}_{q} ( t )\end{matrix} ] = [ \begin{matrix}- \frac{L}{{v}_{dc} ( t )} {k}_{d} {ɛ}_{d} ( t ) \\ - \frac{L}{{v}_{dc} ( t )} {k}_{q} {ɛ}_{q} ( t )\end{matrix} ] + [ \begin{matrix}\frac{{e}_{d}}{{v}_{dc} ( t )} + \frac{L}{{v}_{dc} ( t )} ω {i}_{q} ( t ) \\ \frac{{e}_{q}}{{v}_{dc} ( t )} - \frac{L}{{v}_{dc} ( t )} ω {i}_{d} ( t )\end{matrix} ] \qquad ( 9 )$$

where

$$[ \begin{matrix}\frac{{e}_{d}}{{v}_{dc} ( t )} + \frac{L}{{v}_{dc} ( t )} ω {i}_{q} ( t ) \\ \frac{{e}_{q}}{{v}_{dc} ( t )} - \frac{L}{{v}_{dc} ( t )} ω {i}_{d} ( t )\end{matrix} ]$$

is the compensation offsetting known elements in (8); u_{d}(t) is a d-axis control input of the three-phase power rectifier in the two-phase rotating coordinate system; u_{q}(t) is a q-axis control input of the three-phase power rectifier in the two-phase rotating coordinate system; e_{d} is a d-axis grid voltage in the two-phase rotating coordinate system; e_{q} is a q-axis grid voltage in the two-phase rotating coordinate system; L is the filter inductance of the three-phase power rectifier; co is the grid voltage frequency; i_{d}(t) is a d-axis inductor current of the three-phase power rectifier in the two-phase rotating coordinate system; i_{q}(t) is q-axis inductor current of the three-phase power rectifier in the two-phase rotating coordinate system; v_{dc} (t) is the DC-side voltage of the three-phase power rectifier; ε_{d}(t) is a d-axis current tracking error in the two-phase rotating coordinate system; ε_{q}(t) is a q-axis current tracking error in the two-phase rotating coordinate system; k_{d} is a control parameter in the loop controlling i_{d}; k_{q} is a control parameter in the loop controlling i_{q}; L is the filter inductance of the three-phase power rectifier.

The H controller concerns the control parameters k_{d} and k_{q}. In a preferred embodiment, the control parameters k_{d} and k_{q} can be obtained by the following approach.

By substituting the controller in (8) with (9),

$$[ \begin{matrix}{\dot{ɛ}}_{d} ( t ) \\ {\dot{ɛ}}_{q} ( t )\end{matrix} ] = [ \begin{matrix}- {k}_{d} {ɛ}_{d} ( t ) + {ω}_{d} ( t ) \\ - {k}_{q} {ɛ}_{q} ( t ) - {ω}_{q} ( t )\end{matrix} ] \qquad ( 10 )$$

where

$${ω}_{d} ( t ) = {i}_{d}^{*} + \frac{r}{L} {i}_{d} ( t ) and {ω}_{q} ( t ) = {i}_{q}^{*} + \frac{r}{L} {i}_{q} ( t ) ;$$

they can be considered as external interferences because the current derivative and parasitic resistance are unknown, and can be controlled separately because i_{d} and i_{q} are decoupled.

Given a control indicator γ_{d} of the H_{∞} controller and

$${k}_{d} = \frac{{l}_{d}}{{h}_{d}} ,$$

the current tracking error is asymptotic stable when the following inequality constraint is satisfied:

$$[ \begin{matrix}- 2 {l}_{d} & {h}_{d} & 1 \\ {h}_{d} & - {γ}_{d} & 0 \\ 1 & 0 & - {γ}_{d}\end{matrix} ] \leq 0 \qquad ( 11 )$$

The control parameter k_{q} for i_{q} can be obtained by a similar approach.

l_{q} is a parameter variable of the H_{∞} controller, and h_{q} is a parameter variable of the H_{∞} controller. l_{q} and h_{q} are introduced so that the inequality is transformed into a linear matrix inequality, which facilitates the solving of the control gain of the current tracking loop.

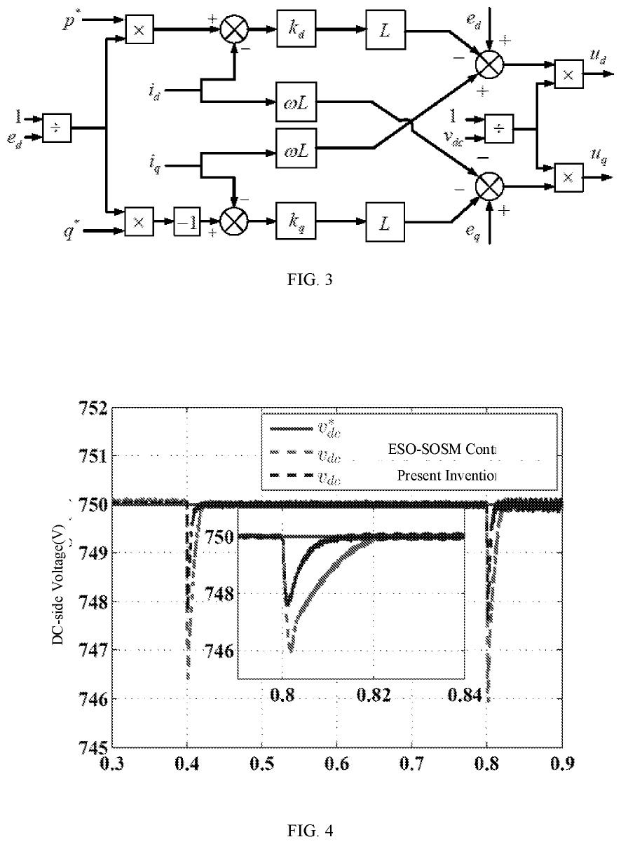

FIG. 3 is a block diagram of the H_{∞} controller according to an embodiment. H_{∞} control is a method used in robust control systems according to modern control theory. H_{∞} control provides a parameter selecting standard for traditional PI control.

An embodiment of the present disclosure also includes an adaptive control device for a three-phase power rectifier. The control device may be realized using a computer processor that executes a computer program that implements the control method according to an embodiment of the present disclosure, or may include a voltage loop control module and a current loop.

The voltage loop control module and the current loop control module may be realized using electronic devices based on the connection relationships shown in FIG. 2 and FIG. 3, respectively.

### Simulation Results of the Embodiment

Simulation results demonstrate effectiveness of the embodiment, with system parameters listed in Table 2. In order to illustrate the comparative advantages of the embodiment of the present disclosure, performance indicators of the system under the control of the embodiment and ESO-SOSM (Extended State Observer Based Second Order Sliding Mode) are compared and analyzed, the system being the three-phase power rectifier.

A. Dynamic Performance

FIG. 4 shows the change of the output DC-side voltage when the load changes from 0Ω, to 60Ω at 0.4 s and then to 30Ω at 0.8 s. It can be seen from FIG. 4 that under the adaptive H_{∞} control algorithm, the system responds faster than under ESO-SOSM, with the time that the system returns to a steady state being 0.01 s and 0.02 s, respectively. In addition, under the control of the embodiment, the system has less overshoot.

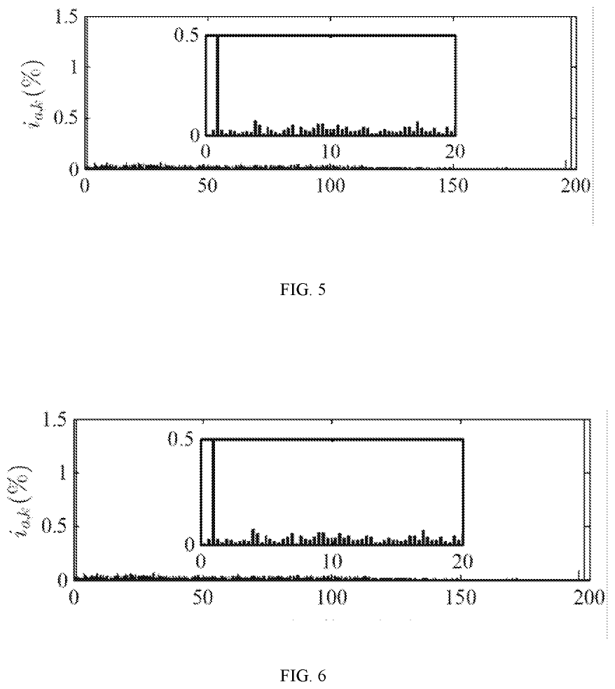

FIG. 5 and FIG. 6 show the harmonic distortion results of current tracking, with the same loads as in FIG. 4. It can be seen that the harmonic distortion under the control of the embodiment is 2.04%, while the harmonic distortion under ESO-SOSM is 3.32%; hence, the method according to the embodiment improves the tracking performance of the current loop.

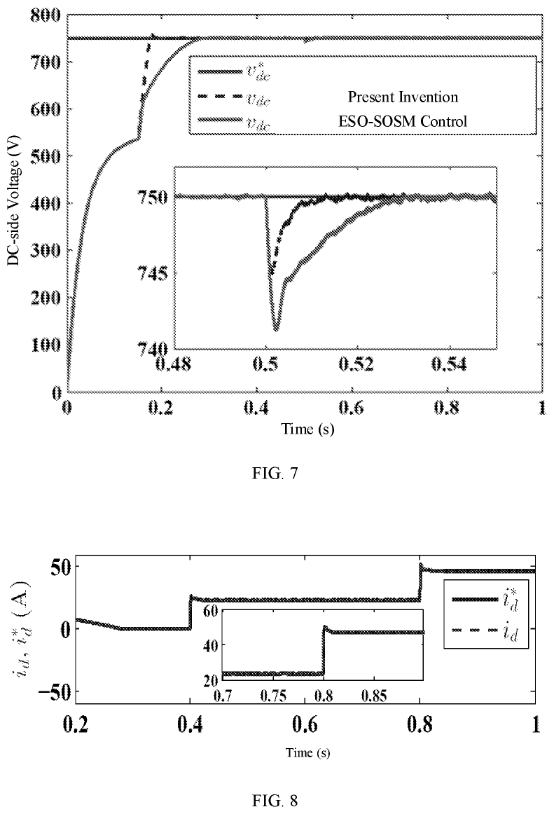

FIG. 7 shows the robustness performance of the two controllers, where both the inductance L and the capacitance C are increased by 10%, a measuring white noise is added to the output voltage and a load is added at 0.5 s from the original 0Ω to 30Ω. FIG. 6 is a diagram of the DC-side voltage, and it can be seen that the control of the embodiment still produces less overshoot and faster response speed as compared with ESO-SOSM.

B. Steady-State Performance

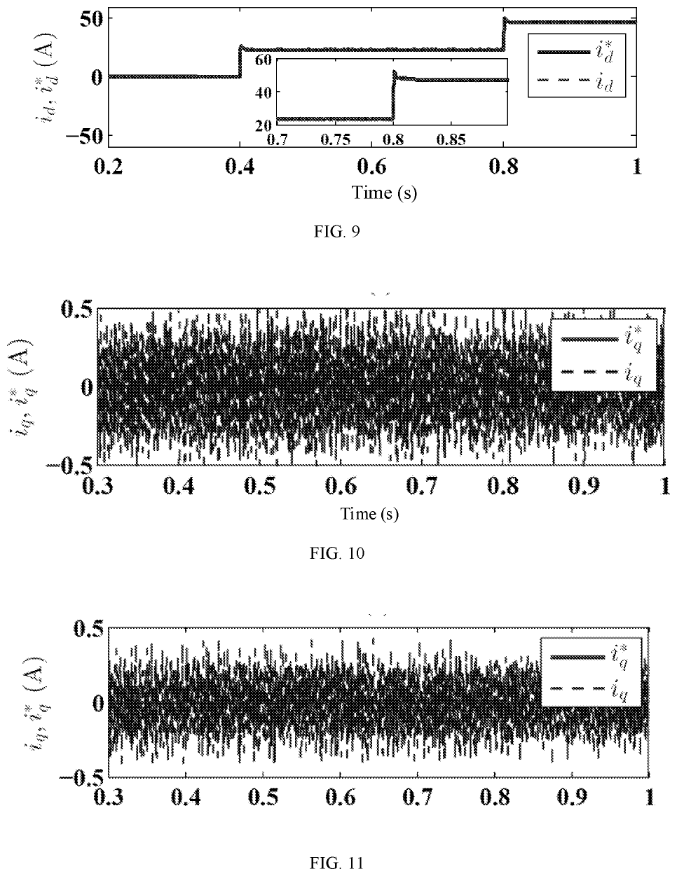

FIG. 8 to FIG. 11 show the tracking results of the system current i_{d}, i_{q}, where the load changes from 0Ω to 60Ω at 0.4 s and then to 30Ω at 0.8 s. Under either of the two control algorithms, current i_{d}, i_{q} tracking can be achieved; but the control of the embodiment produces a smaller tracking error and a better tracking performance.

The present invention is described herein with reference to specific embodiments; however, it should be understood that these embodiments are merely examples of the principles and application examples of the invention. It should therefore be understood that many modifications can be made to the exemplary embodiments, and that other arrangements can be devised without departing from the spirit and scope of the invention as defined by the appended claims. It should be understood that different dependent claims and features described herein may be combined in a manner different from that described in the original claims. It can also be understood that features described in connection with separate embodiments may be used in other described embodiments.

What is claimed is:

1. An adaptive control method for a three-phase power rectifier, comprising:
considering an unknown load as an unknown disturbance, and using an adaptive controller to process the unknown disturbance of the three-phase power rectifier so that a DC-side voltage of the three-phase power rectifier tracks a reference value, to obtain a reference grid current; and,
using an H_{∞} controller to track the reference grid current, to obtain a control input for the three-phase power rectifier, where H_{∞} denotes a magnification ratio of an output to an input of the three-phase power rectifier.

2. The adaptive control method for a three-phase power rectifier according to claim 1, wherein the adaptive controller can be expressed as Equation (1) below:
p*=ke₁(t)+Cx₁(t)\hat{p}(t) (1)
where p* is a reference active power; k is a proportional gain of an error; e₁(t) is the tuning error, e₁(t)=x₁*−x₁(t); \hat{p} is an interference-related estimate, \dot{\hat{p}}(t)=ηx₁(t)e₁(t), with η being an adaptive tuning parameter; x₁* is a tracking reference signal; x₁(t)=½v_{dc}²(t); v_{dc}(t) is the DC-side voltage of the three-phase power rectifier; and C denotes a DC-side capacitance of the three-phase power rectifier.

3. The adaptive control method for a three-phase power rectifier according to claim 2, wherein the H_{∞} controller can be expressed as Equation (2) below:
$$[ \begin{matrix}{u}_{d} ( t ) \\ {u}_{q} ( t )\end{matrix} ] = [ \begin{matrix}- \frac{L}{{v}_{dc} ( t )} {k}_{d} {ɛ}_{d} ( t ) \\ - \frac{L}{{v}_{dc} ( t )} {k}_{q} {ɛ}_{q} ( t )\end{matrix} ] + [ \begin{matrix}\frac{{e}_{d}}{{v}_{dc} ( t )} + \frac{L}{{v}_{dc} ( t )} ω {i}_{q} ( t ) \\ \frac{{e}_{q}}{{v}_{dc} ( t )} - \frac{L}{{v}_{dc} ( t )} ω {i}_{d} ( t )\end{matrix} ] \qquad ( 2 )$$
where u_{d}(t) is a d-axis control input of the three-phase power rectifier in a two-phase rotating coordinate system; u_{q}(t) is a q-axis control input of the three-phase power rectifier in the two-phase rotating coordinate system; e_{d} is a d-axis grid voltage in the two-phase rotating coordinate system; e_{q} is a q-axis grid voltage in the two-phase rotating coordinate system; L is a filter inductance of the three-phase power rectifier; co is a grid voltage frequency; i_{d}(t) is a d-axis inductor current of the three-phase power rectifier in the two-phase rotating coordinate system; i_{q}(t) is q-axis inductor current of the three-phase power rectifier in the two-phase rotating coordinate system; v_{dc}(t) is the DC-side voltage of the three-phase power rectifier; ε_{d}(t) is a d-axis current tracking error in the two-phase rotating coordinate system; ε_{q}(t) is a q-axis current tracking error in the two-phase rotating coordinate system; k_{d} is a control parameter in a loop controlling i_{d}; k_{q} is a control parameter in a loop controlling i_{q}; and L is a filter inductance of the three-phase power rectifier.

4. The adaptive control method for a three-phase power rectifier according to claim 3, wherein k_{d} is obtained by the following approach:
for
$$[ \begin{matrix}{\dot{ɛ}}_{d} ( t ) \\ {\dot{ɛ}}_{q} ( t )\end{matrix} ] = [ \begin{matrix}- {k}_{d} {ɛ}_{d} ( t ) + {ω}_{d} ( t ) \\ - {k}_{q} {ɛ}_{q} ( t ) + {ω}_{q} ( t )\end{matrix} ] ,$$
where ω_{d}(t) is an unknown disturbance to
$${ɛ}_{d} ( t ) , {ω}_{d} ( t ) = {i}_{d}^{*} + \frac{r}{L} {i}_{d} ( t ) ;$$
ω_{q}(t) is an unknown disturbance to
$${ɛ}_{q} ( t ) , {ω}_{q} ( t ) = {i}_{q}^{*} + \frac{r}{L} {i}_{q} ( t ) ;$$
r is a parasitic resistance of the three-phase power rectifier,
given a control indicator γ_{d} of the H_{∞} controller and
$${k}_{d} = \frac{{l}_{d}}{{h}_{d}} ,$$
finding a solution that satisfies
$$[ \begin{matrix}- 2 {l}_{d} & {h}_{d} & 1 \\ {h}_{d} & - {γ}_{d} & 0 \\ 1 & 0 & - {γ}_{d}\end{matrix} ] \leq 0 ,$$
in which case
$$[ \begin{matrix}{\dot{ɛ}}_{d} ( t ) \\ {\dot{ɛ}}_{q} ( t )\end{matrix} ] = [ \begin{matrix}- {k}_{d} {ɛ}_{d} ( t ) + {ω}_{d} ( t ) \\ - {k}_{q} {ɛ}_{q} ( t ) + {ω}_{q} ( t )\end{matrix} ]$$
is stable and the corresponding k_{d} is what is desired,
with l_{d} being a parameter variable of the H_{∞} controller, and h_{d} being a parameter variable of the H_{∞} controller; and,
wherein k_{q} is obtainable by a similar approach.

5. A computer-readable storage apparatus, the computer-readable storage apparatus storing a computer program which, when executed, implements a method according to claim 1.

6. A computer-readable storage apparatus, the computer-readable storage apparatus storing a computer program which, when executed, implements a method according to claim 2.

7. A computer-readable storage apparatus, the computer-readable storage apparatus storing a computer program which, when executed, implements a method according to claim 3.

8. A computer-readable storage apparatus, the computer-readable storage apparatus storing a computer program which, when executed, implements a method according to claim 4.

9. An adaptive control device for a three-phase power rectifier, comprising a storage apparatus, a processor, and a computer program stored on the storage apparatus and executable by the processor, wherein the processor is configured to execute the computer program to implement a method according to claim 1.

10. An adaptive control device for a three-phase power rectifier, comprising a storage apparatus, a processor, and a computer program stored on the storage apparatus and executable by the processor, wherein the processor is configured to execute the computer program to implement a method according to claim 2.

11. An adaptive control device for a three-phase power rectifier, comprising a storage apparatus, a processor, and a computer program stored on the storage apparatus and executable by the processor, wherein the processor is configured to execute the computer program to implement a method according to claim 3.

12. An adaptive control device for a three-phase power rectifier, comprising a storage apparatus, a processor, and a computer program stored on the storage apparatus and executable by the processor, wherein the processor is configured to execute the computer program to implement a method according to claim 4.

13. An adaptive control device for a three-phase power rectifier, comprising:
a voltage loop control module, configured to, by considering an unknown load as an unknown disturbance and using an adaptive controller, process the unknown disturbance of the three-phase power rectifier so that a DC-side voltage of the three-phase power rectifier tracks a reference value, to obtain a reference grid current; and,
a current loop control module, configured to use an H_{∞} controller to track the reference grid current, to obtain a control input for the three-phase power rectifier, where H_{∞} denotes a magnification ratio of an output to an input of the three-phase power rectifier.

14. The adaptive control device for a three-phase power rectifier according to claim 13, wherein the adaptive controller is an electronic device that outputs p*:
p*=ke₁(t)+Cx₁(t)\hat{p}(t)
where p* is a reference active power; k is a proportional gain of an error; e₁(t) is the tuning error, e₁(t)=x₁*−x₁(t); \hat{p} is an interference-related estimate, \dot{\hat{p}}(t)=ηx₁(t)e₁(t), with η being an adaptive tuning parameter; x₁* is a tracking reference signal; x₁(t)=½v_{dc}²(t); v_{dc}(t) is the DC-side voltage of the three-phase power rectifier; and C denotes a DC-side capacitance of the three-phase power rectifier.

15. The adaptive control device for a three-phase power rectifier according to claim 14, wherein the H_{∞} controller is an electronic device that outputs
$$[ \begin{matrix}{u}_{d} ( t ) \\ {u}_{q} ( t )\end{matrix} ] \text{:}$$
$$[ \begin{matrix}{u}_{d} ( t ) \\ {u}_{q} ( t )\end{matrix} ] = [ \begin{matrix}- \frac{L}{{v}_{dc} ( t )} {k}_{d} {ɛ}_{d} ( t ) \\ - \frac{L}{{v}_{dc} ( t )} {k}_{q} {ɛ}_{q} ( t )\end{matrix} ] + [ \begin{matrix}\frac{{e}_{d}}{{v}_{dc} ( t )} + \frac{L}{{v}_{dc} ( t )} ω {i}_{q} ( t ) \\ \frac{{e}_{q}}{{v}_{dc} ( t )} - \frac{L}{{v}_{dc} ( t )} ω {i}_{d} ( t )\end{matrix} ]$$
where u_{d}(t) is a d-axis control input of the three-phase power rectifier in a two-phase rotating coordinate system; u_{q}(t) is a q-axis control input of the three-phase power rectifier in the two-phase rotating coordinate system; e_{d} is a d-axis grid voltage in the two-phase rotating coordinate system; e_{q} is a q-axis grid voltage in the two-phase rotating coordinate system; L is a filter inductance of the three-phase power rectifier; co is a grid voltage frequency; i_{d}(t) is a d-axis inductor current of the three-phase power rectifier in the two-phase rotating coordinate system; i_{q}(t) is q-axis inductor current of the three-phase power rectifier in the two-phase rotating coordinate system; v_{dc}(t) is the DC-side voltage of the three-phase power rectifier; ε_{d}(t) is a d-axis current tracking error in the two-phase rotating coordinate system; ε_{q}(t) is a q-axis current tracking error in the two-phase rotating coordinate system; k_{d} is a control parameter in a loop controlling i_{d}; k_{q} is a control parameter in a loop controlling i_{q}; and L is a filter inductance of the three-phase power rectifier.

16. The adaptive control device for a three-phase power rectifier according to claim 15, wherein:
$${k}_{d} = \frac{{l}_{d}}{{h}_{d}} , [ \begin{matrix}- 2 {l}_{d} & {h}_{d} & 1 \\ {h}_{d} & - {γ}_{d} & 0 \\ 1 & 0 & - {γ}_{d}\end{matrix} ] \leq 0 ,$$
γ_{d} is a control indicator of the H_{∞} controller, l_{d} is a parameter variable of the H_{∞} controller and h_{d} is a parameter variable of the H_{∞} controller; and,
$${k}_{q} = \frac{{l}_{q}}{{h}_{q}} , [ \begin{matrix}- 2 {l}_{q} & {h}_{q} & 1 \\ {h}_{q} & - {γ}_{q} & 0 \\ 1 & 0 & - {γ}_{q}\end{matrix} ] \leq 0 ,$$
γ_{d} is a control indicator of the H_{∞} controller, l_{q} is a parameter variable of the H_{∞} controller and h_{q} is a parameter variable of the H_{∞} controller.
